(19) United States
(12) Patent Application Publication
(10) Pub. No.: US 2012/0284146 A1
(43) Pub. Date: Nov. 8, 2012

(54) ON-STREET PARKING METER SYSTEM SUPPORTING MULTIPLE PAYMENT TOOLS AND SIGNAL TRANSMISSION METHOD THEREOF

(76) Inventor: Ye-Ping WONG, Sanchong City (TW)

(21) Appl. No.: 13/101,196

(22) Filed: May 5, 2011

(51) Int. Cl. G07B 15/02; G06Q 30/00

(52) U.S. Cl. 705/26.41; 705/418

(57) ABSTRACT

In an on-street parking meter system supporting multiple payment tools and signal transmission method thereof, parking meters spaced along streets are divided into multiple groups, each of which includes a main parking meter and multiple secondary parking meters, all of which are equipped with an all-in-one contactless card reader unit compatible with prepaid card, Visa Wave card and MasterCard PayPass card, and a remotely controllable pay-by-phone unit allowing a user to pay by phone. In each group, the main parking meter is provided with both long-range and short-range wireless communication units for bidirectional communication with a back-end parking charge management system and the secondary parking meters, respectively; while the secondary parking meters each are provided with only a short-ranged wireless communication unit for bidirectional communication with the main parking meter. Therefore, the parking meters have small size and reduced power consumption to enable reduced labor cost for replacing batteries thereof.

### FIELD OF THE INVENTION

The present invention relates to an on-street parking meter system supporting multiple payment tools and signal transmission method thereof; and more particularly to an on-street parking meter system supporting multiple payment tools and signal transmission method thereof that utilizes both long-range and short-range wireless communication networks to enable bidirectional data transmission between parking meters and a back-end parking charge management system at reduced power consumption and provides an all-in-one contactless IC card reader unit on each of the parking meters thereof to enable convenient payment of parking fees without increasing the frequency of battery replacements.

### BACKGROUND OF THE INVENTION

With the quick development in the transport facilities in the modern society, more and more people own cars, and it has become an important issue in most big cities to work out an effective plan for providing and managing public parking places in limited urban space. Taiwan Patent Publication No. 414885 discloses a time-based card-operated parking meter system, which utilizes the currently widely existed cabled networks to enable a district parking management system to conveniently communicate with a parking management information center, and to link to Internet or other dedicated lines for data transmission to obtain authentication data for credit card users. The district parking management system includes a sub-control room linked to a plurality of parking meters that are separately mounted to one side of parking spaces. The sub-control room serves to communicate the parking management information center with each of the parking meters. The sub-control room is provided with an input/output device in order to provide a service platform, and is connected to a cabled television centralized control network via a cabled modem.

There are also many on-street parking meters providing relatively new signal transmission ways. These on-street parking meters are equipped with a long-range radio communication system, such as GPRS (General Packet Radio Service), GSM (Global System for Mobile Communications) or trunking radio system. And, it is known the power consumption of the radio communication has a close relation with the range thereof. That is, the application of the parking meters equipped with a long-range radio communication system has the following disadvantages:

(1) The conventional parking meters are battery-powered, and the installation of the GPRS, GSM or trunking radio system in the conventional parking meters for transmitting different messages, such as transaction data or update programs, would consume more battery power. Therefore, more batteries with higher capacity are required for the parking meters. However, since the parking meters are located on streets, they usually have a small size and are therefore not suitable for receiving too many batteries therein.

(2) While the conventional coin-operated on-street parking meters are gradually replaced by card-operated parking meters due to many problems in use, such as the problems of coins collecting, stuck machines and counterfeit coins, the user paying by card has to wait at the parking meter until the latter is connected to a credit card transaction center to obtain an authorization code. Thus, a lot of time is consumed and the public telecommunication resource is occupied. Moreover, the currently available credit card reader occupies a relatively large space and therefore could not be easily installed in the small enclosure of the on-street parking meters. Besides, the currently available prepaid cards and other RFID credit cards for paying small amount offline without the need of signing a credit card voucher, such as the Visa Wave cards and the MasterCard PayPass cards, are not compatible with one another and the on-street parking meters can usually accept only one type of these cards, preventing the user from paying the parking fee conveniently.

(3) Generally, the parking meters are designed to be powered with several pieces of AA batteries to have a three-month or even a six-month duty cycle. However, since all the GPRS, GSM, and trunking radio systems consume a high amount of battery power, the parking meters with the same number of AA batteries but installed with any one of these systems would have a largely shortened duty cycle of one to two weeks. With such shortened duty cycle, numerous time and labor cost are needed to replace the batteries for the tremendous quantity of parking meters in the city.

(4) Currently, all the parking meter manufacturers in the world have been trying to develop a complete and effective automatic car-in/car-out detection system by employing different techniques, such as road-embedded induction coils, infrared detector, digital camera, and so on. However, due to problems in power supply, environmental conditions, man-made interferences, poor illumination, high cost and so on, there is not any parking meter equipped with an ideal automatic car-in/car-out detection system with low error risk available in the market up to date.

It is therefore tried by the inventor to develop an on-street parking meter system supporting multiple payment tools and a signal transmission method thereof to overcome the drawbacks in the conventional and current time-based parking meter systems.

### SUMMARY OF THE INVENTION

A primary objective of the present invention is to provide an on-street parking meter system and signal transmission method thereof that utilizes both long-range and short-range wireless communication networks to enable bidirectional data transmission between parking meters in the system with a back-end parking charge management system, so as to reduce the power consumption of the parking meters and save labor cost for replacing batteries of the parking meters.

Another objective of the present invention is to provide an on-street parking meter system and signal transmission method thereof that supports multiple payment tools by providing an all-in-one contactless IC card reader unit and a remotely controllable pay-by-phone unit on each of the parking meters thereof without increasing an overall size of the parking meters, and allows users to conveniently pay the parking fee by a prepaid card, a Visa Wave card, a MasterCard PayPass card, or a cell phone.

A further objective of the present invention is to provide an on-street parking meter system and signal transmission method thereof that provides an infrared or a laser beam detector on each of the parking meters thereof to enable smart and correct detection of whether a parking space is occupied by a car, as well as timely detection and accordingly quick removal of any abnormal condition in the parking meters.

To achieve the above and other objects, the on-street parking meter system supporting multiple payment tools and signal transmission method thereof according to the present invention includes a plurality of parking meters that are spaced along streets and divided into multiple district-based groups. Each of the district-based groups includes a main parking meter and multiple secondary parking meters, all of which are equipped with an all-in-one contactless IC card reader unit compatible with prepaid card, Visa Wave card and MasterCard PayPass card, and a remotely controllable pay-by-phone unit, so that the parking meters can have a small size while allowing users to pay the parking fee by different cards or cell phone. In each district-based group, the main parking meter is provided with a long-range wireless communication unit for bidirectional communication with a back-end parking charge management system via a long-range wireless communication network and a short-range wireless communication unit for bidirectional communication with the secondary parking meters via a short-range wireless communication network, while the secondary parking meters each are provided with only a short-ranged wireless communication unit for bidirectional communication with the main parking meter via the short-range wireless communication network. Since the short-range wireless communication units have relatively low power consumption compared to the long-range wireless communication units, the provision of only the short-range wireless communication units in the large number of secondary parking meters can effectively reduce an overall power consumption of the whole parking meter system and save a lot of labor for replacing batteries of the parking meters.

### BRIEF DESCRIPTION OF THE DRAWINGS

The structure and the technical means adopted by the present invention to achieve the above and other objectives can be best understood by referring to the following detailed description of the preferred embodiments and the accompanying drawings, wherein

FIG. 1 schematically illustrates multiple district-based groups of on-street parking meters according to an embodiment of an on-street parking meter system supporting multiple payment tools of the present invention;

FIG. 2 is a block diagram showing the relation between the on-street parking meters in one district-based group according to the present invention;

FIG. 3 is a schematic elevational view showing a failed signal transmission in one district-based group of on-street parking meters according to the present invention;

FIG. 4 shows the on-street parking meter system according to the present invention automatically searches for another district-based group of on-street parking meters to support a nearby group with failed signal transmission;

FIG. 5 is a block diagram showing the on-street parking meter system of the present invention and external communication networks linked thereto;

FIG. 6 is a schematic view showing the on-street parking meter according to the present invention with an automatic parking space detection function; and

FIG. 7 is a flowchart showing the steps included in the automatic parking space detection by the on-street parking meters of the present invention.

### DETAILED DESCRIPTION OF THE PREFERRED EMBODIMENTS

The present invention will now be described with a preferred embodiment thereof and with reference to the accompanying drawings.

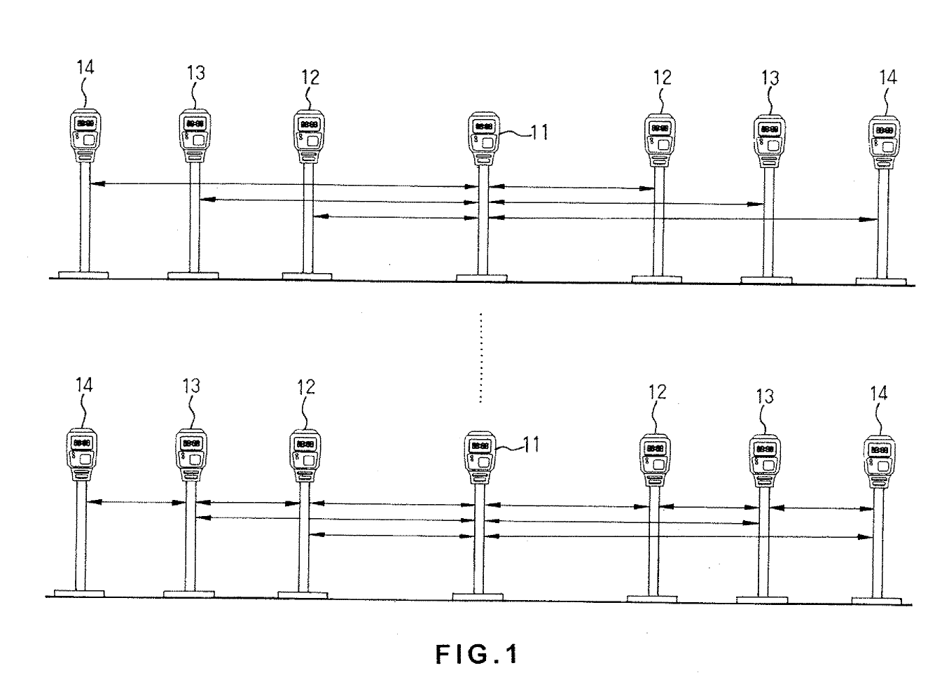

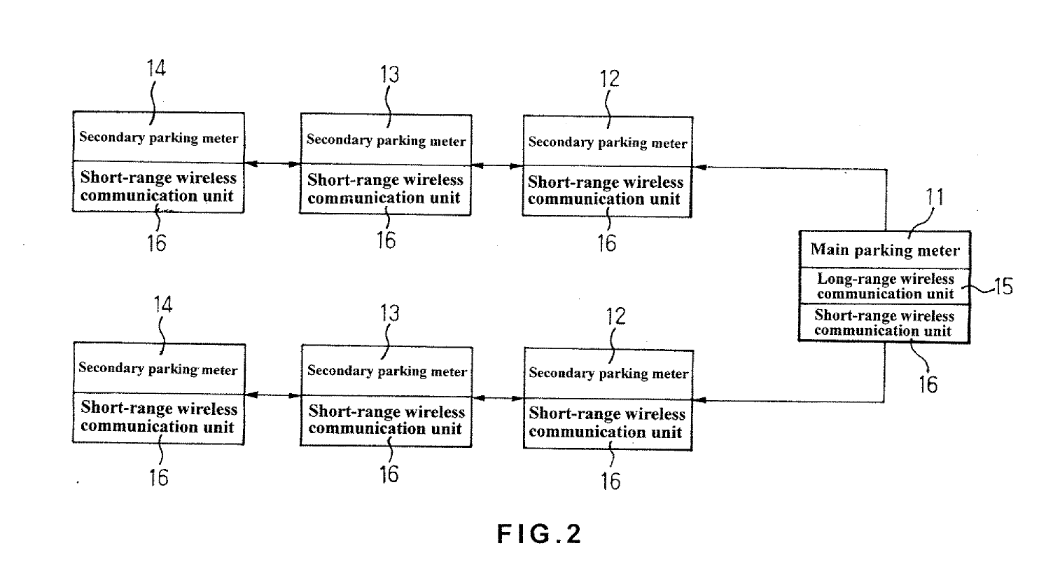

Please refer to FIGS. 1 and 2. An on-street parking meter system supporting multiple payment tools according to a preferred embodiment of the present invention includes a plurality of parking meters spaced along streets. These parking meters are divided into a plurality of district-based groups. In each of the district-based groups of parking meters, there are included a main parking meter 11 and a plurality of secondary parking meters 12, 13, 14. Usually, each of the district-based group includes 10 to 100 secondary parking meters. Each of the main parking meters 11 is internally provided with a long-range and a short-range wireless communication unit 15 and 16, respectively. And, each of the secondary main parking meters 12-14 is internally provided with only a short-range wireless communication unit 16.

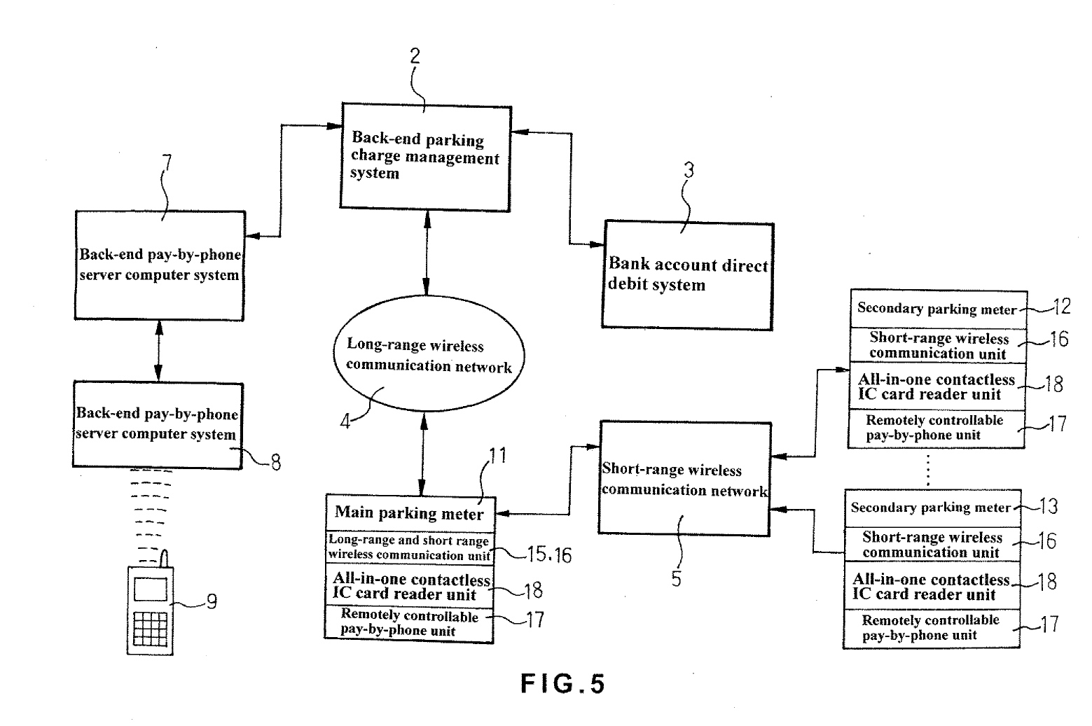

Please refer to FIG. 5. In each district-based group, the main parking meter 11 and the secondary parking meters 12-14 are bi-directionally communicable with one another via a short-range wireless communication network 5. Generally, the short-range wireless communication unit 16 has a communication radius of about 75 meters and consumes relatively low power. Since the secondary parking meters 12-14 in the same group are generally spaced from one another and from the main parking meter 11 by a relatively short distance and have fewer data quantity and simpler functions without requiring high signal transmission speed, operation data of each of the secondary parking meters 12-14 can be relayed or directly transmitted to the main parking meter 11 via the short-range wireless communication units 16 and the short-range wireless communication network 5. On receipt of the operation data of the secondary parking meters 12-14, the main parking meter 11 further directly transfers the related messages to a back-end server computer via the long-range wireless communication unit 15 provided in the main parking meter 11 and a long-range wireless communication network 4. The main parking meter 11 can also transmit various commands to each of the secondary parking meters 12-14 in the same group by way of broadcasting or relaying.

In this manner, only the main parking meters 11 are required to install the GPRS or GSM system to perform remote data transmission. With this design architecture, the parking meter system of the present invention utilizes the long-range and the short-range wireless communication network 4, 5 at the same time to enable bidirectional data transmission, and the main parking meters 11 responsible for the long-range communication in the system can be largely reduced in quantity. Since only the main parking meters 11 require high-capacity batteries or higher frequency of battery replacement while the secondary parking meters 12-14 perform only short-range wireless communication and have lower power consumption, the future maintenance of the whole parking meter system can be more conveniently performed to save a large quantity of time and labor.

Please refer to FIGS. 1 to 5 at the same time. The following describes a specific data transmission method adopted by the parking meter system according to the present invention:

(1) In each of the district-based groups, the secondary parking meters 12-14 respectively communicate with and send data to the main parking meter 11 via the short-range wireless communication network 5.

(2) To save power consumption, the long-range wireless communication units 15 provided on the main parking meters 11 in the system are usually turned off or are intermittently turned on and off while the short-range wireless communication units 16 thereof are kept in a standby state. When any of the secondary parking meters 12-14 in one district-based group has data that is to be sent back to the back-end server computer via the main parking meter 11, a signal corresponding to the data is transmitted via the short-range wireless communication unit 16 in the secondary parking meter 12, 13 or 14 to the short-range wireless communication unit 16 in the main parking meter 11, and then, the main parking meter 11 further performs remote data transmission via its long-range wireless communication unit 15 to transmit the received signal to the back-end server computer, so as to achieve the purpose of saving power.

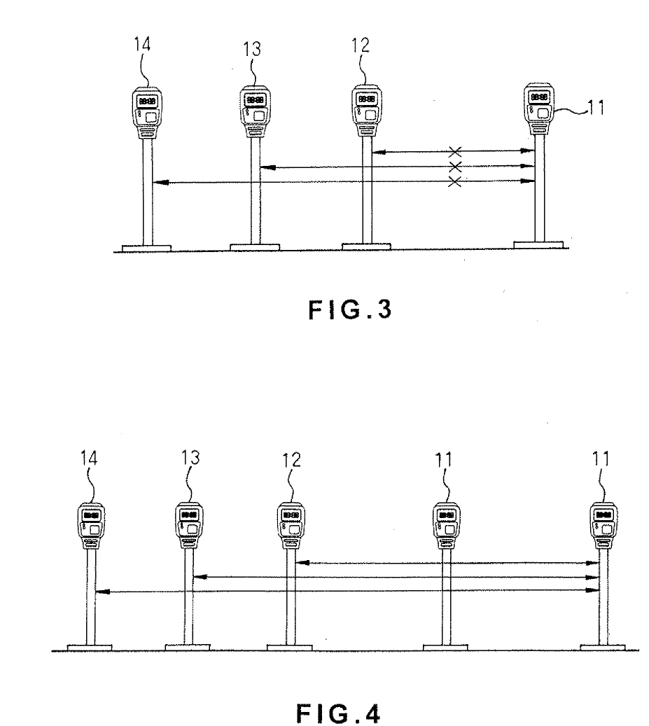

(3) In the event the main parking meter 11 in one district-based group of parking meters is failed, as shown in FIG. 3, the secondary parking meters 12-14 in the group is linked to a main parking meter 11 in another preset district-based group that is closest to the group with the failed main parking meter, as shown in FIG. 4, to maintain the data transmission from the secondary parking meters.

Please refer to FIG. 5 again. In implementing the present invention, a remotely controllable pay-by-phone unit 17 and an all-in-one contactless integrated circuit (IC) card reader unit 18 are further provided on each of the main and the secondary parking meters 11 and 12-14. The all-in-one contactless IC card reader unit 18 is compatible with not only the prepaid card, but also the Visa Wave card and the MasterCard PayPass card. Each of the main parking meters 11 can be linked to a back-end parking charge management system 2 via the long-range wireless communication network 4, so that data of parking charges occurred at the parking meters 11-14 in all the district-based groups can be sent or relayed to and computed by the back-end parking charge management system 2. And, the back-end parking charge management system 2 is further linked to and communicable with a bank account direct debit system 3 and a back-end pay-by-phone server computer system 7, so that parking fees can be directly debited from users' bank accounts, credit card accounts, or telephone payment accounts. In this manner, when parking a car, a user can have multiple payment options at the same one parking meter, including swiping a contactless IC prepaid card, Visa Wave card or MasterCard PayPass card via the all-in-one contactless IC card reader unit 18, or paying by dialing a cell phone via the remotely controllable pay-by-phone unit 17. By using these advanced and convenient payment tool options, the parking meters of the present invention are able to replace the conventional on-street parking meters and overcome the inconveniences in paying parking fees by inserting coins or swiping a specified credit card on the parking meter.

When a user pays the parking fee by dialing a cell phone 9 under guidance of a pay-by-phone voice guide system 8, the back-end parking charge management system 2 will immediately receive a corresponding payment record, which is used as a basis for direct debiting from the user's bank account or telephone payment account later. To provide the user with humanized service and to upgrade the parking management personnel's working efficiency, the on-street parking meter system of the present invention would automatically send the parking message to the parking meter being used by the user for the parking meter to start counting down. Meanwhile, a short message is sent to the user's cell phone to acknowledge the parking payment.

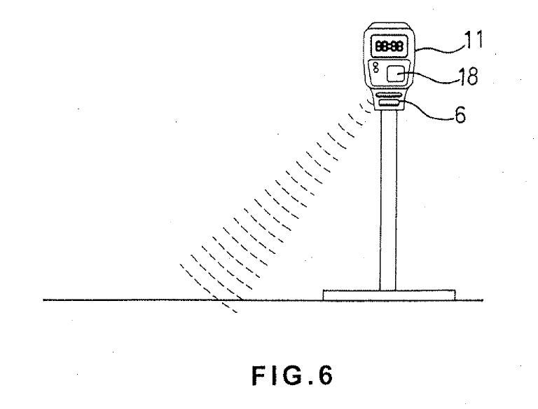

Before the paid parking time is expired and when an infrared or laser beam detector 6 provided on the parking meter (see FIG. 6) detects that the parking space is still occupied, the parking meter system would send the user another short message as reminder, such as “Would you like to purchase more parking time?” The user receiving the message may purchase more parking time at a remote location by dialing the cell phone again. Each time the user buys parking time with cell phone, the back-end parking charge management system 2 immediately transmits the parking time newly purchased by the user to the parking meter corresponding to the user's parking space via the long-range and the short-range wireless communication network 4, 5 and shows the parking time on a display 18 (see FIG. 6) provided on the parking meter, so that the parking time is synchronously displayed on the user's cell phone and the parking meter as soon as the user pays the parking fee by cell phone.

From the above description, it is understood the parking meters in the on-street parking meter system supporting multiple payment tools according to the present invention each are equipped with an all-in-one contactless IC card reader unit, which accepts Visa Wave card, MasterCard PayPass card and prepaid card, allowing users to have multiple parking payment options. With the present invention, users can pay parking fees with great convenience, and the parking meters do not require different and independent card readers and can therefore advantageously have a size as small as possible to avoid adverse influences on the city environment and traffic safety.

Please refer to FIG. 6. To achieve perfect operation of the on-street parking meter system of the present invention, each of the parking meters 11-14 is provided with an infrared or a laser beam detector 6 for detecting whether a parking space corresponding thereto is occupied by a car.

Although the recently developed infrared detection elements are largely improved in terms of their low power consumption and small size, they are frequently maliciously vandalized when being installed on the outdoor parking meters, such as being covered with tapes, and therefore fail to perform normal detection to cause errors.

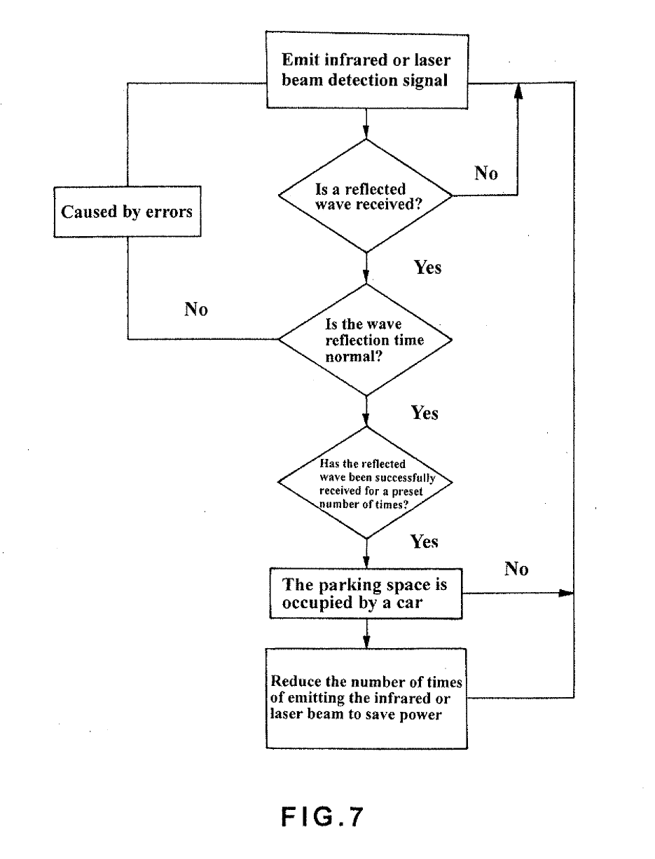

To overcome the errors of the detector 6 possibly caused by man-made factors and to upgrade the reliability of the on-street parking meters to a commercially acceptable level, the detectors 6 provided on the parking meters of the present invention are able to execute automatic parking space detection. FIG. 7 is a flowchart showing the steps included in the automatic parking space detection according to the present invention.

As shown, after a detection signal wave is emitted from the detector 6, the detector 6 first determines whether any reflected wave is received by the detector, and then determines whether the wave reflection time is normal, and finally determines whether the reflected wave has been successfully received for a preset number of times. If it is positive in all three determinations, the detector 6 determines the parking space is occupied by a car and reduces the number of times of emitting the infrared or laser beam to save power. On the other hand, if it is negative in all three determinations, the detector 6 will emit the detection signal wave again. Further, in the event the wave reflection time is abnormal for a continuous period of time, the detector 6 determines there is an error and the abnormality is reported for timely removal of factors causing the abnormality.

According to the present invention, each time the detection signal is emitted, the on-street parking meter system will analyze to find out a difference between the last wave reflection time and previous wave reflection time. When an on-street parking space is vacant, each emission of detection wave thereto should have generally similar wave reflection time. On the other hand, when the parking space is occupied by a car, the emitted detection wave shall have a wave reflection time different from that when the parking space is vacant. In this manner, it is able to determine whether a parking space is occupied or not.

In the event the detector 6 is vandalized, such as being maliciously covered with tape or being blocked by something maliciously positioned in front of the detector 6, the wave reflection time and the intensity of the reflected wave will be different from that when the parking space is normally occupied by a car. Thus, when any of the detectors 6 on the parking meters 11-14 determines there is an abnormal signal wave reflection condition, the abnormal condition is reported via the short-range and the long-range wireless communication network 5, 4 to the back-end parking charge management system 2, so that a manager on-duty can go to the site to timely remove the factors causing such abnormal condition.

With the above arrangements, the on-street parking meter system and signal transmission method thereof according to the present invention is superior to the prior art because the parking meters in the present invention are respectively equipped with an all-in-one contactless IC card reader unit and a remotely controllable pay-by-phone unit to provide users with multiple parking payment options and utilize long-range and short-range wireless communication networks to enable power-saving signal transmission between them. Therefore, the present invention is improved and industrially valuable and practical for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An on-street parking meter system supporting multiple payment tools, comprising a plurality of parking meters spaced along streets and being divided into a plurality of district-based groups, each of the district-based groups including a main parking meter and a plurality of secondary parking meters; each of the main and the secondary parking meters being equipped with an all-in-one contactless IC card reader unit compatible with prepaid card, Visa Wave card and MasterCard PayPass card allowing a user to pay by card, and a remotely controllable pay-by-phone unit allowing a user to pay by a cell phone; whereby the system allows users to have multiple payment options and pay parking fees conveniently.

2. A signal transmission method for on-street parking meter system, comprising the steps of:
providing a plurality of parking meters spaced along streets and dividing the parking meters into a plurality of district-based groups, such that each of the district-based groups including a main parking meter and a plurality of secondary parking meters;
providing a long-range wireless communication unit and a short-range wireless communication unit in each of the main parking meters;
providing a short-range wireless communication unit in each of the secondary parking meters;
providing a detector on each of the main and the secondary parking meters;
the secondary parking meters in the same one district-based group communicating with the main parking meter of the same group via the short-range wireless communication units thereof and a short-range wireless communication network to relay or directly transmit parking-charge-related messages or data to the main parking meter; and
the main parking meter in each of the district-based groups communicating with a computer in a back-end parking charge management system via the long-range wireless communication unit and a long-range wireless communication network to directly transmit the received parking-charge-related messages or data to the back-end parking charge management system.

3. The signal transmission method for on-street parking meter system as claimed in claim 2, further comprising the following step: in the event of a failed main parking meter, the secondary parking meters in the same district-based group transmit or relay the parking-charge-related messages to the main parking meter in another preset district-based group that is closest to the group with the failed main parking meter.

4. The signal transmission method for on-street parking meter system as claimed in claim 2, further comprising the steps of:
providing an all-in-one contactless IC card reader unit and a remotely controllable pay-by-phone unit in each of the main parking meters and the secondary parking meters; the all-in-one contactless IC card reader unit allowing a user to pay parking fee by swiping a prepaid card, a Visa Wave card or a MasterCard PayPass card, and the remotely controllable pay-by-phone unit allowing a user to pay parking fee by dialing a cell phone;
linking each of the main parking meters to the back-end parking charge management system via the long-range wireless communication network, so that data about parking charge occurred at each of the main and secondary parking meters in each of the district-based groups is sent or relayed to and computed by the back-end parking charge management system; wherein in the case of paying by card, the parking-charge-related messages or data can be transmitted to the back-end parking charge management system in real time or at regular intervals in batch;
linking the back-end parking charge management system to a back-end pay-by-phone server computer system and a pay-by-phone voice guide system, whereby when a user selecting to pay by phone is guided by the pay-by-phone voice guide system to dial the cell phone, the back-end parking charge management system immediately receives a record of payment, which is used as a basis for collecting money later, and automatically sends a short message about the payment to the user's cell phone;
when a parking time period bought by a user for a parking space via cell phone is about to become expired, the detector provided on the parking meter corresponding to the parking space emitting detection signal wave to detect whether the parking space is still occupied by a car, and if yes, the back-end parking charge management system sending a short message to remind the user to purchase more parking time; and when the user receiving the message purchases more parking time at a remote location by dialing the cell phone again, the back-end parking charge management system immediately transmitting data of the new parking time to the parking meter via the long-range and the short-range wireless communication network, and synchronously displaying the new parking time on the user's cell phone and a display on the parking meter; and
linking the back-end parking charge management system to a bank account direct debit system for collecting parking payments through direct debiting from the user's credit card account, bank account, or phone payment account.

5. The signal transmission method for on-street parking meter system as claimed in claim 4, wherein the detector is selected from the group consisting of an infrared detector and a laser beam detector, and wherein the detector detects whether a parking space is occupied by a car by emitting detection signal wave toward the parking space, determining whether a reflected wave is received or not, then determining whether a normal wave reflection time is detected, and further determining whether the reflected wave has been successfully received for a preset number of times; and wherein when it is positive in all three determinations, the detector determines the parking space is occupied by a car and emits the detection signal wave at reduced number of times to save power; or when it is negative in all three determinations, the detector emits the detection signal wave again; and wherein when the detected wave reflection time is abnormal for a continuous period of time, the detector determines there is an error and an abnormality is reported.
